(19) United States
(12) Patent Application Publication
(10) Pub. No.: US 2012/0125963 A1
(43) Pub. Date: May 24, 2012

(54) CONTAINER STORAGE APPARATUS

(76) Inventor: Carl Cholin Awh, Nashville, TN (US)

(21) Appl. No.: 13/290,433

(22) Filed: Nov. 7, 2011

Related U.S. Application Data
(60) Provisional application No. 61/416,966, filed on Nov. 24, 2010.

(51) Int. Cl. B62J 11/00

(52) U.S. Cl. 224/457

(57) ABSTRACT

Illustratively, a storage apparatus may comprise an attachment mechanism configured to attach the storage apparatus to a vehicle, a guidance mechanism configured to guide a storage of a container in the storage apparatus, and a container storage mechanism configured to store the container. In one or more embodiments, a vehicle operator may store a container in a storage apparatus attached to a vehicle using tactile guidance. Illustratively, a vehicle operator may tactilely locate a guidance mechanism configured to guide a storage of a container in the storage apparatus. In one or more embodiments, a vehicle operator may utilize the guidance mechanism to tactilely guide a storage of the container without requiring the vehicle operator's vision.

### CROSS-REFERENCE TO RELATED APPLICATIONS

This Application claims the benefit of U.S. Provisional Application No. 61/416,966, filed Nov. 24, 2010.

### FIELD OF THE INVENTION

The present disclosure relates to a storage apparatus for storing a container, and, more particularly, to a storage apparatus for storing a container by tactile guidance.

### BACKGROUND OF THE INVENTION

Personal transportation vehicles, e.g., bicycles, are commonly used for both utilitarian and recreational purposes. When using personal transportation vehicles, it is often desirable to have access to a container of water or other fluid, e.g., a water bottle. Typically, a container may be stored in a storage apparatus, e.g., a water bottle cage, which may be attached to a vehicle. A container stored in a storage apparatus may be accessed, e.g., by a vehicle operator. Illustratively, a vehicle operator may access a container, e.g., to consume fluid. An accessed container may be disposed of or stored again in the storage apparatus.

However, storing a container in a storage apparatus often requires vision and attention in order to successfully store the container in the storage apparatus. This requirement may create a serious safety hazard for a vehicle operator if the vehicle operator's vision and attention are also required to perform other tasks, e.g., safely operating a vehicle. For example, a vehicle operator often needs to divert his or her vision and attention away from operating a vehicle in order to locate a storage apparatus, and store a container in the storage apparatus. Accordingly, there is a need for a storage apparatus for storing a container without requiring a vehicle operator's vision to successfully store the container.

### BRIEF SUMMARY OF THE INVENTION

The present disclosure provides a storage apparatus for storing a container by tactile guidance. In one or more embodiments, a storage apparatus may comprise a guidance mechanism configured to guide a storage of a container in the storage apparatus without requiring a vehicle operator's vision to store the container. Illustratively, a storage apparatus may comprise an attachment mechanism configured to attach the storage apparatus to a vehicle, a guidance mechanism configured to guide a storage of a container in the storage apparatus, and a container storage mechanism configured to store a container. In one or more embodiments, a vehicle operator may store a container in a storage apparatus attached to a vehicle using tactile guidance. Illustratively, a vehicle operator may tactilely locate a guidance mechanism configured to guide a storage of a container in the storage apparatus. In one or more embodiments, a vehicle operator may utilize the guidance mechanism to tactilely guide a storage of the container without requiring the vehicle operator's vision.

### BRIEF DESCRIPTION OF THE DRAWINGS

The above and further advantages of the present invention may be better understood by referring to the following description in conjunction with the accompanying drawings in which like reference numerals indicate identical or functionally similar elements:

FIG. 1 is a schematic diagram of a side view of a storage apparatus for storing a container;

FIG. 2 is a schematic diagram illustrating a side view of an attachment mechanism;

FIG. 3 is a schematic diagram of a front view of a storage apparatus for storing a container;

FIG. 4 is a schematic diagram illustrating a front view of an attachment mechanism;

FIG. 5 is a schematic diagram illustrating a storage apparatus for storing a container;

FIG. 6 is a schematic diagram illustrating a storage apparatus for storing a container;

FIGS. 7A, 7B, and 7C are schematic diagrams illustrating a storage of a container;

FIGS. 8A, 8B, 8C, and 8D are schematic diagrams illustrating a storage of a container;

FIGS. 9A, 9B, and 9C are schematic diagrams illustrating a side view of a versatile mechanism for guiding a container into a storage mechanism;

FIG. 10 is a schematic diagram illustrating a universal guidance mechanism for tactilely guiding a storage of a container.

### DETAILED DESCRIPTION OF AN ILLUSTRATIVE EMBODIMENT

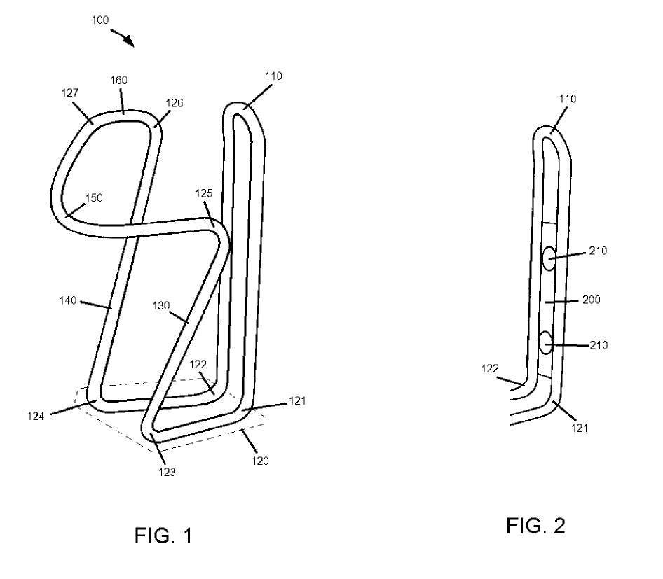

FIG. 1 is a schematic diagram of a side view of a storage apparatus 100 for storing a container. In one or more embodiments, storage apparatus 100 may comprise a back support mechanism 110 configured to support one or more portions of a container. Illustratively, back support mechanism 110 may be connected to a bottom support mechanism 120, e.g., at support transition points 121 and 122. In one or more embodiments, bottom support mechanism 120 may be configured to support one or more portions of a container stored in storage apparatus 100. Illustratively, bottom support mechanism 120 may be connected to a side support mechanism 130, e.g., at support transition point 123. In one or more embodiments, side support mechanism 130 may be configured to support one or more portions of a container stored in storage apparatus 100. Illustratively, side support mechanism 130 may be connected to a front support mechanism 150, e.g., at support transition point 125. In one or more embodiments, front support mechanism 150 may be configured to support one or more portions of a container stored in storage apparatus 100.

Illustratively, bottom support mechanism 120 may be connected to a guide mechanism 140, e.g., at support transition point 124. In one or more embodiments, guide mechanism 140 may be configured to guide a storage of a container in storage apparatus 100. Illustratively, guide mechanism 140 may be configured to support one or more portions of a container stored in storage apparatus 100. In one or more embodiments, guide mechanism 140 may be connected to a guide crest 160, e.g., at support transition point 126. Illustratively, guide crest 160 may be connected to front support mechanism 150, e.g., at support transition point 127.

In one or more embodiments, front support mechanism 150 may be located at a first height above bottom support mechanism 120. Illustratively, guide crest 160 may be located at a second height above bottom support mechanism 120. In one or more embodiments, the second height above bottom support mechanism 120 may be greater than the first height above bottom support mechanism 120.

Illustratively, a vehicle operator may tactilely store a container in storage apparatus 100, e.g., by guiding the container generally towards storage apparatus 100. In one or more embodiments, a vehicle operator may tactilely locate guide crest 160 or a portion of guide mechanism 140. Illustratively, guide mechanism 140 may be configured to enable a vehicle operator to tactilely guide the container between back support mechanism 110, bottom support mechanism 120, side support mechanism 130, guide mechanism 140, and front support mechanism 150.

In one or more embodiments, storage apparatus 100 may be manufactured from any suitable material, e.g., polymers, metals, metal alloys, etc., or from any combination of suitable materials. For example, storage apparatus 100 may be manufactured entirely from a rigid material, e.g., steel, titanium, or one or more metal alloys. Illustratively, storage apparatus 100 may be manufactured entirely from a semi-rigid material, e.g., plastics, polymers, etc. In one or more embodiments, storage apparatus 100 may be manufactured in part from one or more rigid materials and in part from one or more semi-rigid materials.

FIG. 2 is a schematic diagram illustrating a side view of an attachment mechanism 200. In one or more embodiments, attachment mechanism 200 may be configured to attach a storage apparatus 100 to a portion of a vehicle. Illustratively, attachment mechanism 200 may be disposed in back support mechanism 110. In one or more embodiments, attachment mechanism 200 may comprise one or more attachment interfaces 210. Illustratively, attachment mechanism 200 may be attached to a vehicle via attachment interface 210. In one or more embodiments, an attachment, e.g., of a storage apparatus 100 to a portion of a vehicle, may be accomplished by any suitable means for permanently or temporarily affixing attachment mechanism 200 to a vehicle. For example, attachment of storage apparatus 100 may be accomplished by screws, bolts, nails, magnets, etc. Illustratively, affixing storage apparatus 100 to a vehicle does not need to be accomplished via attachment interface 210. For example, attachment of storage apparatus 100 may be accomplished with straps, tape, adhesive material, magnets, etc.

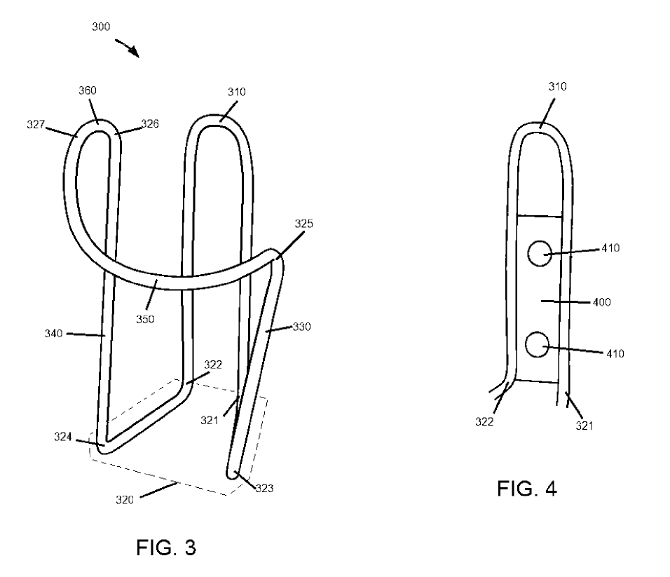

FIG. 3 is a schematic diagram of a front view of a storage apparatus 300 for storing a container. In one or more embodiments, storage apparatus 300 may comprise a back support mechanism 310 configured to support one or more portions of a container. Illustratively, back support mechanism 310 may be connected to a bottom support mechanism 320, e.g., at support transition points 321 and 322. In one or more embodiments, bottom support mechanism 320 may be configured to support one or more portions of a container stored in storage apparatus 300. Illustratively, bottom support mechanism 320 may be connected to a side support mechanism 330, e.g., at support transition point 323. In one or more embodiments, side support mechanism 330 may be configured to support one or more portions of a container stored in storage apparatus 300. Illustratively, side support mechanism 330 may be connected to a front support mechanism 350, e.g., at support transition point 325. In one or more embodiments, front support mechanism 350 may be configured to support one or more portions of a container stored in storage apparatus 300.

Illustratively, bottom support mechanism 320 may be connected to a guide mechanism 340, e.g., at support transition point 324. In one or more embodiments, guide mechanism 340 may be configured to guide a storage of a container in storage apparatus 300. Illustratively, guide mechanism 340 may be configured to support one or more portions of a container stored in storage apparatus 300. For example, guide mechanism 340 may be connected to a guide crest 360, e.g., at support transition point 326. Illustratively, guide crest 360 may be connected to front support mechanism 350, e.g., at support transition point 327.

In one or more embodiments, front support mechanism 350 may be located at a first height above bottom support mechanism 320. Illustratively, guide crest 360 may be located at a second height above bottom support mechanism 320. In one or more embodiments, the second height above bottom support mechanism 320 may be greater than the first height above bottom support mechanism 320.

Illustratively, a vehicle operator may tactilely store a container in storage apparatus 300, e.g., by guiding the container generally towards storage apparatus 300. In one or more embodiments, a vehicle operator may tactilely locate guide crest 360 or a portion of guide support mechanism 340. Illustratively, guide support mechanism 340 may be configured to enable a vehicle operator to tactilely guide a container between back support mechanism 310, bottom support mechanism 320, side support mechanism 330, guide support mechanism 340, and front support mechanism 350.

FIG. 4 is a schematic diagram illustrating a front view of an attachment mechanism 400. In one or more embodiments, attachment mechanism 400 may be configured to attach a storage apparatus 300 to a portion of a vehicle. Illustratively, attachment mechanism 400 may be disposed in back support mechanism 310. In one or more embodiments, attachment mechanism 400 may comprise one or more attachment interfaces 410. Illustratively, attachment mechanism 400 may be attached to a vehicle via attachment interface 410. In one or more embodiments, an attachment, e.g., of storage apparatus 300 to a portion of a vehicle, may be accomplished by any suitable means for permanently or temporarily affixing attachment mechanism 400 to a vehicle. For example, attachment of storage apparatus 300 may be accomplished by screws, bolts, nails, magnets, etc. Illustratively, affixing storage apparatus 300 to a vehicle does not need to be accomplished via attachment interface 410. For example, attachment of storage apparatus 300 may be accomplished with straps, tape, adhesive material, magnets, etc.

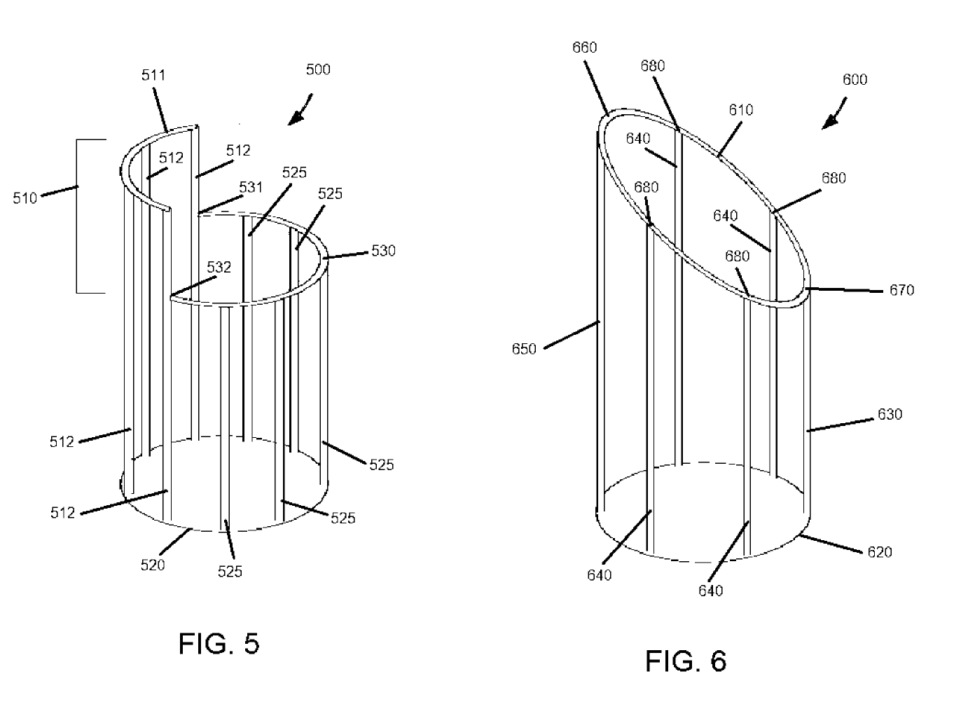

FIG. 5 is a schematic diagram illustrating a storage apparatus 500 for storing a container. In one or more embodiments, storage apparatus 500 may comprise a guidance mechanism 510. Illustratively, guidance mechanism 510 may be configured to tactilely guide a storage of a container in storage apparatus 500. In one or more embodiments, guidance mechanism 510 may comprise a guidance crest 511. Illustratively, guidance crest 511 may be attached to a storage bottom 520, e.g., by one or more guidance supports 512. In one or more embodiments, guidance supports 512 may be configured to tactilely guide a storage of a container in storage apparatus 500. Illustratively, guidance supports 512 may be configured to support one or more portions of a container stored in storage apparatus 500. In one or more embodiments, storage bottom 520 may be configured to support one or more portions of a container stored in storage apparatus 500.

Illustratively, storage bottom 520 may be connected to an access mechanism 530, e.g., by one or more container supports 525. In one or more embodiments, container supports 525 may be configured to support one or more portions of a container stored in storage apparatus 500. Illustratively, access mechanism 530 may be connected to guidance mechanism 510, e.g., by connection interfaces 531 and 532. In one or more embodiments, access mechanism 530 may be configured to support one or more portions of a container stored in storage apparatus 500. For example, access mechanism 530 may be configured to enable a vehicle operator to access a container stored in storage apparatus 500.

In one or more embodiments, storage bottom 520 and access mechanism 530 may be separated by a first distance. Illustratively, storage bottom 520 and guidance crest 511 may be separated by a second distance. In one or more embodiments, the second distance may be greater than the first distance. Illustratively, a difference between the second distance and the first distance may comprise a height of guidance mechanism 510. In one or more embodiments, a height of guidance mechanism 510 may be configured to tactilely guide a storage of a particular container in storage apparatus 500. For example, a height of guidance mechanism 510 may be configured to extend a particular distance above access mechanism 530, e.g., to tactilely guide a storage of a particular container in storage apparatus 500. Illustratively, the particular distance above access mechanism 530 may be configured to correspond to one or more dimensions of a particular container. For example, the particular distance above access mechanism 530 may be configured to correspond to at least a fraction of a height of a particular container.

Illustratively, a vehicle operator may store a container in storage apparatus 500, e.g., by moving a container generally towards guidance mechanism 510. For example, as a container approaches guidance mechanism 510, a vehicle operator may tactilely identify guidance mechanism 510. In one or more embodiments, guidance mechanism 510 may be configured to guide a storage of a container in storage apparatus 500. Illustratively, a container stored in storage apparatus 500 may be supported by storage bottom 520, guidance supports 512, and container supports 525.

FIG. 6 is a schematic diagram illustrating a storage apparatus 600 for storing a container. In one or more embodiments, storage apparatus 600 may comprise a container access portion 610 and a container support portion 620. Illustratively, container support portion 620 may be configured to support one or more portions of a container stored in storage apparatus 600. In one or more embodiments, container access portion 610 may be configured to enable container ingress, e.g., for storage, and container egress, e.g., from storage, in storage apparatus 600. Illustratively, container access portion 610 may be connected to container support portion 620 by one or more short container supports 630, one or more intermediate container supports 640, and one or more long container supports 650. In one or more embodiments, long container support 650 may connect a guidance crest 660 of container access portion 610 to container support portion 620. Illustratively, short container supports 630 may connect a guidance trough 670 of container access portion 610 to container support portion 620. In one or more embodiments, one or more intermediate supports 640 may connect container support portion 620 to container access portion 610, e.g., at points 680.

Illustratively, a vehicle operator may store a container in storage apparatus 600, e.g., by moving the container generally toward guidance crest 660. In one or more embodiments, as a container begins to contact guidance crest 660 or long container support 650, a vehicle operator may tactilely control a guidance of the container along long container support 650 towards container support portion 620. Illustratively, container support portion 620, one or more short container supports 630, one or more intermediate container supports 640, and one or more long container supports 650 may support a container stored in storage apparatus 600.

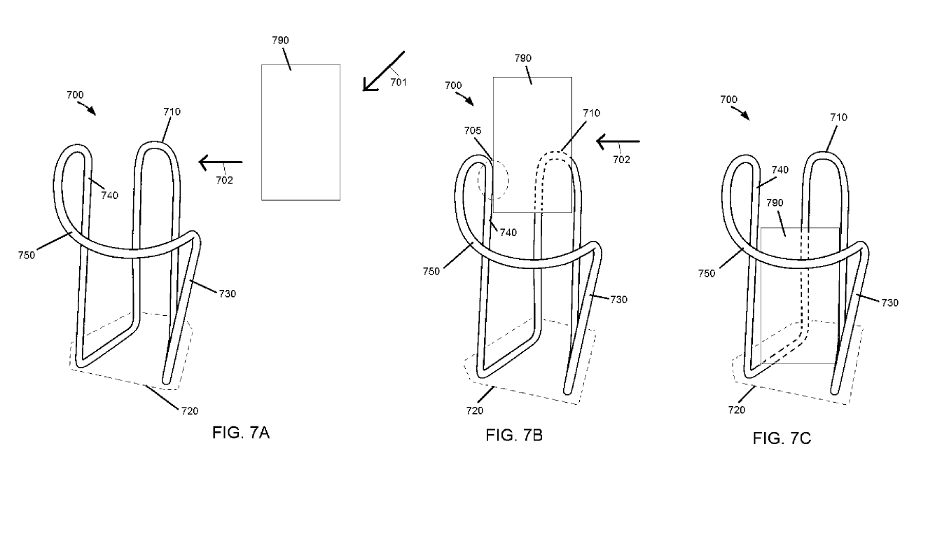

FIGS. 7A, 7B, and 7C are schematic diagrams illustrating a storage of a container 790. FIG. 7A illustrates a container 790 approaching a storage apparatus 700 from an approach vector 701. Illustratively, container 790 may be guided by a vehicle operator towards storage apparatus 700, e.g., along a storage attempt vector 702. In one or more embodiments, storage apparatus 700 may comprise a back support mechanism 710 configured to support one or more portions of container 790, a bottom support mechanism 720 configured to support one or more portions of a container 790, a side support mechanism 730 configured to support one or more portions of a container 790, a front support mechanism 750 configured to support one or more portions of a container 790, and a guide mechanism 740. Illustratively, guide mechanism 740 may be configured to guide a storage of a container 790 in storage apparatus 700. In one or more embodiments, guide mechanism 740 may be configured to support one or more portions of a container 790 stored in storage apparatus 700.

FIG. 7B illustrates a progression of container 790, e.g., along storage attempt vector 702, until a contact 705 is made between container 790 and guide mechanism 740. FIG. 7C illustrates container 790 stored in storage apparatus 700. Illustratively, a vehicle operator may store a container 790 in storage apparatus 700, e.g., by generally guiding container 790 towards storage apparatus 700, e.g., along storage attempt vector 702. In one or more embodiments, container 790 may eventually contact 705 guide mechanism 740. Illustratively, after locating guide mechanism 740, e.g., by contact 705, a vehicle operator may tactilely guide container 790 along guide mechanism 740 until container 790 is stored in storage apparatus 700.

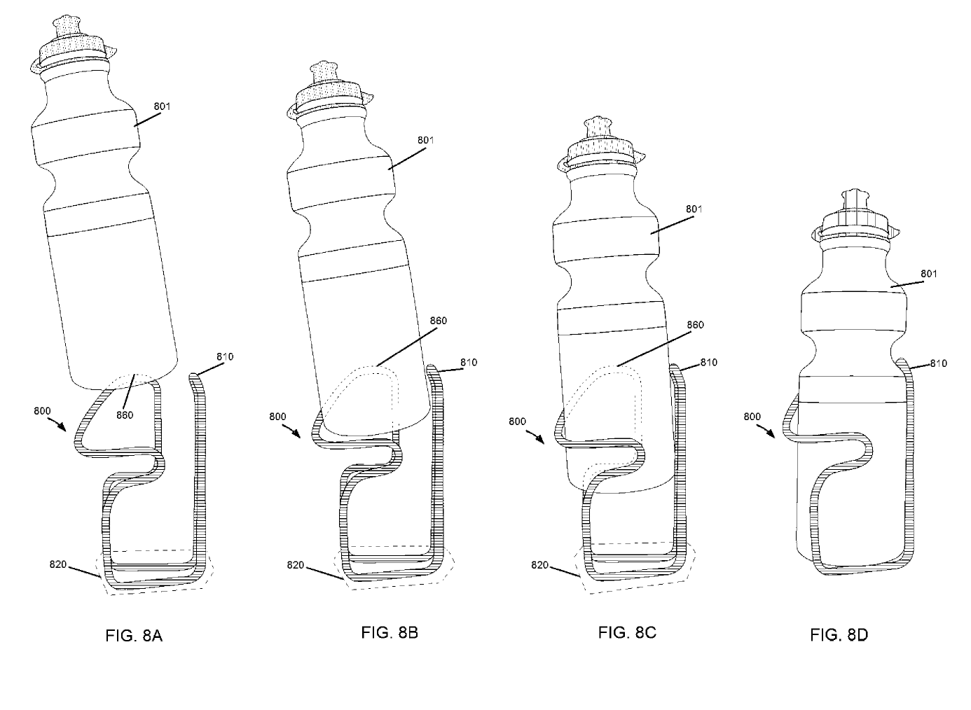

FIGS. 8A, 8B, 8C, and 8D are schematic diagrams illustrating a storage of a container 801. FIG. 8A illustrates a portion of a storage of a container 801 in a storage apparatus 800. In one or more embodiments, storage apparatus 800 may comprise a back support mechanism 810, a bottom support system 820, and a guide mechanism 860. Illustratively, guide mechanism 860 may be configured to guide a storage of container 801 in storage apparatus 800. In one or more embodiments, back support mechanism 810 may be configured to support one or more portions of container 801 stored in storage apparatus 800. Illustratively, bottom support system 820 may be configured to support one or more portions of container 801 stored in storage apparatus 800.

In one or more embodiments, container 801 may contact storage apparatus 800, e.g., to initiate a storing of container 801 in storage apparatus 800. Illustratively, container 801 may contact a guide mechanism 860 of storage apparatus 800, e.g., to initiate a storing of container 801 in storage apparatus 800. In one or more embodiments, a contact between container 801 and storage apparatus 800 may tactilely indicate, e.g., to a vehicle operator, that a storage of container 801 in storage apparatus 800 may be performed, e.g., by the vehicle operator. Illustratively, a contact between container 801 and storage apparatus 800 may tactilely apprise, e.g., a vehicle operator, of a location of container 801 relative to storage apparatus 800. In one or more embodiments, a contact between container 801 and guide mechanism 860 may be configured to initiate a guidance of a storage of container 801 in storage apparatus 800.

FIG. 8B illustrates a portion of a storage of a container 801 in a storage apparatus 800. Illustratively, container 801 may contact guide mechanism 860. In one or more embodiments, guide mechanism 860 may be configured to facilitate a guidance of a storage of container 801 in storage apparatus 800. Illustratively, guide mechanism 860 may be configured to initiate a guidance of a storage of container 801 in storage apparatus 800.

FIG. 8C illustrates a portion of a storage of a container 801 in a storage apparatus 800. Illustratively, container 801 may be tactilely guided, e.g., by contact with guide mechanism 860, to a storage in storage apparatus 800. In one or more embodiments, guide mechanism 860 may be configured to facilitate a guidance of a storage of container 801 in storage apparatus 800. Illustratively, guide mechanism 860 may be configured to support one or more portions of container 801, e.g., when stored in storage apparatus 800.

FIG. 8D illustrates a portion of a storage of container 801 in storage apparatus 800. Illustratively, container 801 may be stored in storage apparatus, e.g., with tactile guidance, via guidance mechanism 860. In one or more embodiments, container 801 may be partially supported by back support mechanism 810. Illustratively, container 801 may be partially supported by bottom support system 820. In one or more embodiments, container 801 may be partially supported by guide mechanism 860.

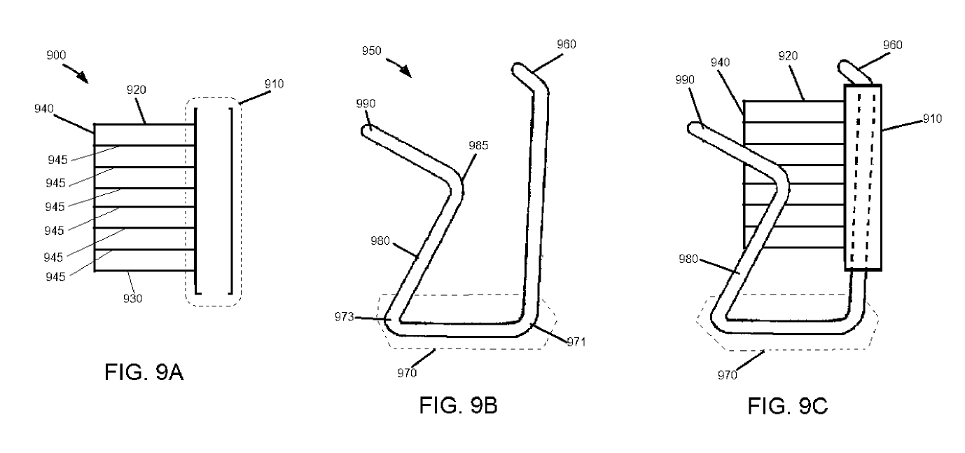

FIGS. 9A, 9B, and 9C are schematic diagrams illustrating a side view of versatile mechanism 900 for guiding a container into a storage mechanism 950. FIG. 9A illustrates a versatile mechanism 900. In one or more embodiments, versatile mechanism 900 may be configured to couple to storage mechanism 950. Illustratively, while coupled to storage mechanism 950, versatile mechanism 900 may be configured to tactilely guide a storage of a container in storage mechanism 950. In one or more embodiments, storage mechanism 950 may be specifically designed to couple to versatile mechanism 900. Illustratively, storage mechanism 950 may comprise a generic storage mechanism and versatile mechanism 900 may be specifically designed to couple to storage mechanism 950.

In one or more embodiments, versatile mechanism 900 may comprise a coupling mechanism 910 that may be configured to couple versatile mechanism 900 to storage mechanism 950. Illustratively, coupling mechanism 910 may be connected to a guidance crest 920. In one or more embodiments, coupling mechanism 910 may be connected to a guidance bottom 930. Illustratively, guidance bottom 930 and guidance crest 920 may be affixed to a guidance structure 940. In one or more embodiments, guidance structure 940 may be configured to facilitate tactile guidance of a storage of a container in storage mechanism 950. Illustratively, guidance structure 940 may comprise one or more truss members 945 configured to provide structural support for guidance structure 940.

FIG. 9B illustrates a storage mechanism 950 for storing a container. In one or more embodiments, storage mechanism 950 may comprise a back support mechanism 960 configured to support one or more portions of a container. Illustratively, back support mechanism 960 may be connected to a bottom support mechanism 970, e.g., at one or more support transition points 971. In one or more embodiments, bottom support mechanism 970 may be configured to support one or more portions of a container stored in storage mechanism 950. Illustratively, bottom support mechanism 970 may be connected to at least one side support mechanism 980, e.g., at one or more support transition points 973. In one or more embodiments, at least one side support mechanism 980 may be configured to support one or more portions of a container stored in storage mechanism 950. Illustratively, at least one side support mechanism 980 may be connected to a front support mechanism 990, e.g., at one or more support transition points 985. In one or more embodiments, front support mechanism 990 may be configured to support one or more portions of a container stored in storage mechanism 950.

FIG. 9C illustrates versatile mechanism 900 coupled to a storage mechanism 950 for storing a container. In one or more embodiments, versatile mechanism 900 may be coupled to storage mechanism 950, e.g., by coupling mechanism 910. Illustratively, coupling mechanism 910 may be configured to fit over back support mechanism 960. In one or more embodiments, coupling mechanism 910 may be configured to fit behind back support mechanism 960, e.g., coupling mechanism 910 may fit between an attachment mechanism 200 and a vehicle. Illustratively, versatile mechanism 900 may be coupled to storage mechanism 950 by any suitable means for permanently or temporarily affixing coupling mechanism 910 to back support mechanism 960. For example, attachment of versatile mechanism 900 may be accomplished by screws, bolts, nails, magnets, etc. In one or more embodiments, coupling mechanism 910 may be affixed to storage mechanism 950 via one or more attachment interfaces 210. Illustratively, affixing versatile mechanism 900 to storage mechanism 950 does not need to be accomplished via coupling mechanism 910. For example, attachment of versatile mechanism 900 to storage mechanism 950 may be accomplished with straps, tape, adhesive material, magnets, etc.

In one or more embodiments, versatile mechanism 900 may be configured to tactilely guide a storage of a container in storage mechanism 950. Illustratively, a vehicle operator may tactilely store a container in storage mechanism 950, e.g., by guiding the container generally towards storage mechanism 950. In one or more embodiments, a vehicle operator may tactilely locate guidance crest 920 or a portion of guidance structure 940. Illustratively, guidance structure 940 may be configured to enable a vehicle operator to tactilely guide the container between back support mechanism 960, bottom support mechanism 970, side support mechanism 980, guidance structure 940, and front support mechanism 990.

In one or more embodiments, versatile mechanism 900 may be coupled to storage mechanism 950, e.g., with guidance structure 940 disposed on either side of front support mechanism 990. FIG. 9C illustrates a side-view of guidance structure 940 disposed on a distal side of front support mechanism 990. In one or more embodiments, a vehicle operator may tactilely store a container in storage mechanism 950, e.g., by guiding the container generally towards a proximal side of storage mechanism 950. Illustratively, a vehicle operator may tactilely locate guidance crest 920 or a portion of guidance structure 940 and tactilely guide a container between back support mechanism 960, bottom support mechanism 970, side support mechanism 980, guidance structure 940, and front support mechanism 990. In one or more embodiments, versatile mechanism 900 may be coupled to storage mechanism 950 with guidance structure 940 disposed on a proximal side of front support mechanism 990. Illustratively, a vehicle operator may tactilely store a container in storage mechanism 950, e.g., by guiding the container generally towards a distal side of storage mechanism 950. In one or more embodiments, a vehicle operator may tactilely locate guidance crest 920 or a portion of guidance structure 940 and tactilely guide a container between back support mechanism 960, bottom support mechanism 970, side support mechanism 980, guidance structure 940, and front support mechanism 990.

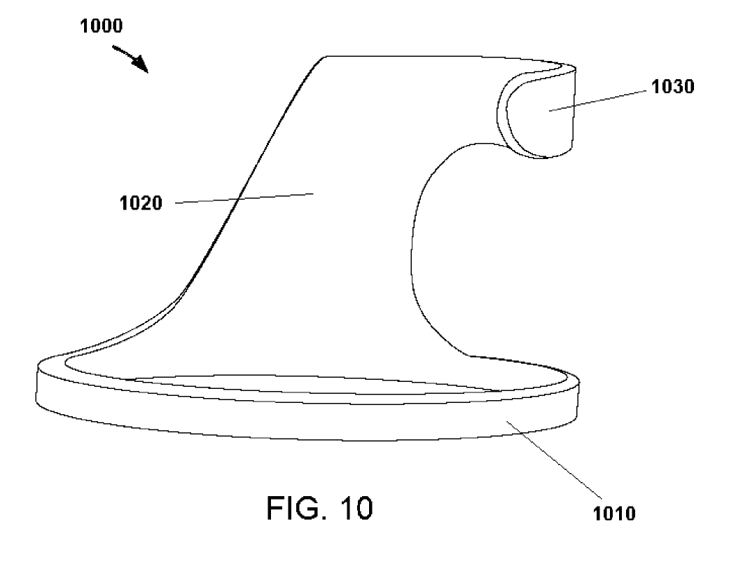

FIG. 10 is a schematic diagram illustrating a universal guidance mechanism 1000 for tactilely guiding a storage of a container. In one or more embodiments, universal guidance mechanism 1000 may be configured to interface with a storage mechanism and enable tactile guidance of a storage of a container within the storage mechanism. Illustratively, universal guidance mechanism 1000 may comprise a storage mechanism interface 1010 configured to interface with a storage mechanism without substantially perturbing the functionality of the storage mechanism, e.g., storage mechanism interface 1010 may be configured to synergistically integrate universal guidance mechanism 1000 with a storage mechanism. In one or more embodiments, storage mechanism interface 1010 may be configured to integrate universal guidance mechanism 1000 with a storage mechanism wherein a container that may be stored in the storage mechanism alone, i.e., without integration of universal guidance mechanism 1000, may also be stored in the storage mechanism while integrated with universal guidance mechanism 1000. Illustratively, storage mechanism interface 1010 may be connected to a support structure 1020. In one or more embodiments, support structure 1020 may be configured to provide structural support for universal storage mechanism 1000. Illustratively, support structure 1020 may be configured to support one or more portions of a container stored in a storage mechanism. In one or more embodiments, support structure 1020 may be configured to provide a tactile guidance of a storage of a container in a storage mechanism. Illustratively, support structure 1020 may be connected to a tactile guidance mechanism 1030. In one or more embodiments, tactile guidance mechanism 1030 may be configured to tactilely guide a storage of a container in a storage mechanism. For example, a storage mechanism, e.g., an automobile cup holder, may be integrated with universal guidance mechanism 1000 by disposing storage mechanism interface 1010 at a base of the automobile cup holder. Illustratively, a tactile storage of a container, e.g., a cup, may be performed, e.g., by a vehicle operator, by guiding the cup generally towards the automobile cup holder and universal guidance mechanism 1000. In one or more embodiments, as a cup approaches the automobile cup holder, a vehicle operator may tactilely identify universal guidance mechanism 1000 and tactilely guide a storage of the cup in the cup holder, e.g., via tactile guidance mechanism 1030.

The foregoing description has been directed to particular embodiments of this invention. It will be apparent; however, that other variations and modifications may be made to the described embodiments, with the attainment of some or all of their advantages. Specifically, it should be noted that the principles of the present invention may be implemented in any storage system. Furthermore, while this description has been written in terms of a storage apparatus, the teachings of the present invention are equally suitable to systems where the functionality containment may be employed. Therefore, it is the object of the appended claims to cover all such variations and modifications as come within the true spirit and scope of the invention.

What is claimed is:

1. A storage apparatus comprising:
a storage bottom;
an access mechanism attached to the storage bottom, the access mechanism extending a first distance from the storage bottom;
a guidance mechanism configured to tactilely guide a storage of a container in the storage apparatus; and
a guidance crest of the guidance mechanism, the guidance crest extending a second distance from the storage bottom.

2. The storage apparatus of claim 1 wherein the second distance from the storage bottom is greater than the first distance from the storage bottom.

3. The storage apparatus of claim 2 wherein a difference between the second distance from the storage bottom and the first distance from the storage bottom comprises a height of the guidance mechanism.

4. The storage apparatus of claim 3 wherein the difference between the second distance from the storage bottom and the first distance from the storage bottom is at least a fraction of a height of the container.

5. The storage apparatus of claim 1 further comprising:
an attachment mechanism configured to attach the storage apparatus to a portion of a vehicle.

6. The storage apparatus of claim 5 wherein the attachment mechanism is configured to temporarily attach the storage apparatus to the portion of the vehicle.

7. The storage apparatus of claim 5 wherein the attachment mechanism is configured to permanently attach the storage apparatus to the portion of the vehicle.

8. The storage apparatus of claim 1 further comprising:
a guidance support attached to both the guidance crest and the storage bottom; and
a container support attached to both the access mechanism and the storage bottom.

9. The storage apparatus of claim 8 wherein the guidance support is configured to tactilely guide the storage of the container in the storage apparatus.

10. The storage apparatus of claim 1 further comprising:
a guidance trough; and
a short container support connected to both the guidance trough and the storage bottom.

11. The storage apparatus of claim 5 wherein the vehicle comprises a bicycle.

12. The storage apparatus of claim 1 wherein the container is configured to store a fluid.

13. The storage apparatus of claim 1 wherein the container comprises a water bottle.

14. A versatile mechanism comprising:
a coupling mechanism configured to couple the versatile mechanism to a storage mechanism; and
a guidance structure attached to the coupling mechanism, the guidance structure configured to tactilely guide a storage of a container in the storage mechanism.

15. The versatile mechanism of claim 14 further comprising:
a guidance crest of the guidance structure; and
a guidance bottom of the guidance structure.

16. A universal guidance mechanism comprising:
a storage mechanism interface configured to interface with a storage mechanism;
a support structure; and
a tactile guidance mechanism configured to tactilely guide a storage of a container in the storage mechanism.
